(19) United States
(12) Patent Application Publication
(10) Pub. No.: US 2012/0293892 A1
(43) Pub. Date: Nov. 22, 2012

(54) POWER PROTECTION CIRCUIT

(75) Inventors: KAI-FU CHEN, Tu-Cheng (TW); CHIA-YUN LEE, Tu-Cheng (TW); CHUANG-WEI TSENG, Tu-Cheng (TW)

(73) Assignee: HON HAI PRECISION INDUSTRY CO., LTD., Tu-Cheng (TW)

(21) Appl. No.: 13/207,188

(22) Filed: Aug. 10, 2011

(30) Foreign Application Priority Data
May 20, 2011 (TW) 100117875

(51) Int. Cl. H02H 3/02

(52) U.S. Cl. 361/18

(57) ABSTRACT

A power protection circuit includes a fuse, a plurality of voltage converters, and controller. The fuse is electrically connected to a power source to transfer electric energy. The controller controls the fuse and the voltage converters, and the voltage converters are selectably electrically connected to or disconnected from the power source through the fuse. When the output voltage of a voltage converter exceeds a predetermined voltage of the voltage converter, the controller blows the fuse to the voltage converters. Hence, a computer cannot be restarted immediately before troubleshooting and replacement of the blown fuse, which can protect the voltage converters and the adjacent components in the computer due to direct reboot.

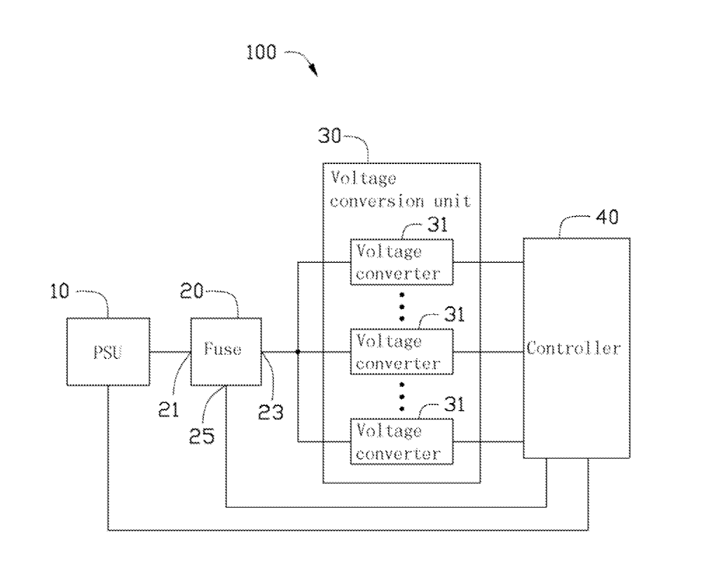

### BACKGROUND

1. Technical field

The disclosure generally relates to power protection circuits, and particularly to a power protection circuit for motherboards.

2. Description of the Related Art

Motherboards are generally used to hold many of the components such as CPU, power supply rails, and integrated circuits (ICs) in many computers. Each component has different protection features such as over voltage protection, under voltage protection, and over current protection. For example, when the power supply rail enters any of the protection modes, the computer may be powered off.

However, when the computer is powered off, it is difficult to figure out which crucial components are out of order. Thus, when the computer is directly restarted, the crucial components may be damaged due to overload, device failure or excessive current, which further damages the computer system.

Therefore, there is room for improvement within the art.

### BRIEF DESCRIPTION OF THE DRAWINGS

Many aspects of a power protection circuit can be better understood with reference to the following drawings. The components in the drawings are not necessarily drawn to scale, the emphasis instead being placed upon clearly illustrating the principles of the power protection circuit. Moreover, in the drawings, like reference numerals designate corresponding parts throughout the several views. Wherever possible, the same reference numbers are used throughout the drawings to refer to the same or like elements of an embodiment.

The drawing is a block view of a power protection circuit, according to an embodiment of the disclosure.

### DETAILED DESCRIPTION

The drawing shows a block view of a power protection circuit 100 according to an embodiment of the disclosure. The power protection circuit 100 may be used in a computer (not shown) and protects the computer from damage due to over voltage, over current and under voltage. In this embodiment, the power protection circuit 100 includes a power supply unit (PSU) 10, a fuse 20, a voltage conversion unit 30, and a controller 40.

The PSU 10 is electrically connected to a power source (not shown) and can supply direct current (DC) power to the other components in the computer. In this embodiment, the PSU 10 converts general-purpose alternating current (AC) electric power from the power source (e.g., 110V to 120V at 60 Hz, 220V to 240V at 50 Hz) to a low-voltage (e.g., 12V, 5V and 24V) DC power for the internal components of the computer.

The fuse 20 is a type of sacrificial overcurrent protection device that interrupts excessive current resulting from overload or device failure so that further damage by overheating or fire is prevented. In this embodiment, the fuse 20 includes an input port 21, an output port 23, and a control port 25. The input port 21 is electrically connected to the PSU 10, the output port 23 is electrically connected to the voltage conversion unit 30, and the control port 25 is electrically connected to the controller 40. Thus, when the control port 25 receives a command signal from the controller 40, the fuse 20 is blew due to excessive current. In this embodiment, the command signal can be a current signal.

The voltage conversion unit 30 includes a plurality of voltage converters 31, which are electrically connected between the output port 23 of the fuse 20 and the controller 40 in parallel. The voltage converters 31 are capable of converting voltages from the PSU 10 to corresponding operating voltages providing for different components in the computer. For example, one of the voltage converters 31 converts a 12V from the PSU 10 to a corresponding 5V operating voltage, and the other voltage converter 31 convert a 12V from the PSU 10 into corresponding 3.2V, 1.8V and 1.2V operating voltages.

In this embodiment, each voltage converter 31 has a protection feature including over voltage protection (OVP) mode, under voltage protection (UVP) mode and over current protection (OCP) mode. When the output voltage of the voltage converters 31 is greater than its predetermined threshold voltage, the voltage converters 31 will be inactivated and stop working due to overvoltage, overload or overcurrent and then send a feedback signal to the controller 40.

The controller 40 is electrically connected to the PSU 10 and the fuse 20. When the controller 40 receives the feedback signals from the voltage converters 31, the controller 40 controls the computer shutdown and sends corresponding command signals to the fuse 20 to blow the fuse 20, avoiding further damage by overheating or fire. Thus, the PSU 10 is disconnected from the voltage conversion unit 30, so the computer cannot be restarted immediately. In this embodiment, when the computer needs to reboot, a new fuse 20 is needed to replace the blown one, which can avoid damaging the voltage converters 31 and the adjacent components in the computer.

In this embodiment, the controller 40 can be a power timing controller. The controller 40 outputs and sends corresponding enable signals to the voltage converters 31 and the PSU 10 to control and activate the PSU 10 and the voltage converters 31. When the voltage converters 31 work normally, the voltage converters 31 then transmit a valid feedback signal to the controller 40. When the voltage converters 31 enter the protection mode due to overvoltage, overcurrent or device failure, the voltage converters 31 transmits an invalid feedback signal to the controller 40. The controller 40 controls the computer shutdown and sends a command signal to blow the fuse 20 according to the invalid feedback signal, avoiding further damage by overheating or fire. Thus, the computer cannot be directly restarted, which can avoid damaging the voltage converters 31 and the adjacent components in the computer due to direct reboot. In this embodiment, the enable signals are logic 1 signals, and the valid feedback signal is a logic 1 signal.

In summary, in the power protection circuit 100 of the embodiment of this disclosure, the voltage converters 31 are electrically connected to a power source through the fuse 20. Thus, when the controller 40 receives an invalid feedback signal from the voltage converters 31 due to excessive current resulting from overload or device failure, the voltage converters 31 are in the protection mode, the fuse 20 is melted. Hence, further damage by overheating or fire is prevented. Moreover, the computer cannot be restarted immediately before troubleshooting and replacement of the blown fuse, which can protect the voltage converters 31 and the adjacent components in the computer due to direct reboot.

In the present specification and claims the word “a” or “an” preceding an element does not exclude the presence of a plurality of such elements. Further, the word “comprising” does not exclude the presence of other elements or steps than those listed.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A power protection circuit, comprising:
a fuse electrically connected to a power source to transfer electric energy;
a plurality of voltage converters electrically connected to the fuse, each voltage converter outputting a different output voltage; and
a controller electrically connected to the fuse and the voltage converters, wherein the controller controls the fuse and the voltage converters, whereby when the output voltage of one of the voltage converter exceeds a predetermined voltage of the voltage converter, the controller blows the fuse to the voltage converters.

2. The power protection circuit as claimed in claim 1, further comprising a power supply unit (PSU) electrically connected between the power source and the fuse, wherein the PSU converts alternating current electric power from the power source to a low voltage direct current power.

3. The power protection circuit as claimed in claim 2, wherein the fuse comprises an input port, an output port and a control port, the input port is electrically connected to the PSU, the output port is electrically connected to the voltage conversion unit, and the control port is electrically connected to the controller, and the when the control port receives a command signal from the controller, the fuse is blown to disconnect the PSU and the voltage converters.

4. The power protection circuit as claimed in claim 3, wherein the voltage converters are electrically connected between the output port of the fuse and the controller in parallel, and the voltage converters convert voltages from the PSU to different operating voltages for corresponding to each of different components.

5. The power protection circuit as claimed in claim 4, wherein when the output voltage of any voltage converter exceeds its predetermined operating voltage, the voltage converter is disabled and inactivated and sends an invalid feedback signal to the controller.

6. The power protection circuit as claimed in claim 5, wherein when the controller receives the invalid feedback signal from a voltage converter, the controller sends corresponding command signals to the fuse according to the invalid feedback signal, to blow the fuse with the PSU.

7. The power protection circuit as claimed in claim 5, wherein the valid feedback signal is a logic 1 signal, the controller is a power timing controller.

8. A power protection circuit, comprising:
a power supply unit (PSU) electrically connected to a power source, the PSU outputting a voltage;
a fuse electrically connected to the PSU;
a voltage conversion unit electrically connected to the fuse, the voltage conversion unit comprising a plurality of voltage converters to output different output voltages; and
a controller electrically connected to the fuse and the voltage converters, wherein the PSU is selectably electrically connected to or disconnected from the voltage converters through the fuse, when the output voltage of one of the voltage converters exceeds a predetermined operating voltage, the controller generates and sends a command signal to the fuse to separate the connection between the PSU and the voltage converters.

9. The power protection circuit as claimed in claim 8, wherein the PSU converts alternating current electric power from the power source to a low voltage direct current power.

10. The power protection circuit as claimed in claim 8, wherein the fuse comprises an input port, an output port and a control port, the input port is electrically connected to the PSU, the output port is electrically connected to the voltage conversion unit, and the control port is electrically connected to the controller, and the when the control port receives the command signal from the controller, the fuse is blown to disconnect the PSU and the voltage converters.

11. The power protection circuit as claimed in claim 10, wherein the voltage converters are electrically connected between the output port of the fuse and the controller in parallel, and the voltage converters convert voltages from the PSU to different operating voltages for corresponding each of the different components.

12. The power protection circuit as claimed in claim 11, wherein when the output voltage of any voltage converter exceeds its predetermined operating voltage, the voltage converter is disabled and inactivated and sends an invalid feedback signal to the controller.

13. The power protection circuit as claimed in claim 12, wherein when the controller receives the invalid feedback signal from a voltage converter, the controller sends corresponding command signals to the fuse according to the invalid feedback signal, to blow the fuse from the PSU.

14. The power protection circuit as claimed in claim 12, wherein the valid feedback signal is a logic 1 signal, the controller is a power timing controller.
